(19) United States
(12) Patent Application Publication
(10) Pub. No.: US 2020/0183217 A1
(43) Pub. Date: Jun. 11, 2020

(54) DISPLAY DEVICE

(71) Applicant: AU OPTRONICS CORPORATION, Hsin-Chu (TW)

(72) Inventor: CHIEN-TING LIAO, Hsin-Chu (TW)

(21) Appl. No.: 16/692,117

(22) Filed: Nov. 22, 2019

Related U.S. Application Data
(60) Provisional application No. 62/775,480, filed on Dec. 5, 2018.

(30) Foreign Application Priority Data
Aug. 14, 2019 (TW) 108128840

(51) Int. Cl. G02F 1/1333; F21V 8/00; G02F 1/1335

(52) U.S. Cl. CPC G02F 1/133308; G02F 2001/133317; G02F 1/133524; G02B 6/0088

(57) ABSTRACT

The present invention provides a display device including a back bezel, a frame, a display panel, and a tape. The back bezel includes a base plate and a wall extending along a periphery of the base plate, and has a first side edge and a second side edge intersecting the first side edge. At the first side edge, the back bezel further has a separating plate extending and protruding towards the interior of the back bezel. The frame is disposed along the periphery of the base plate, and has a side wall portion and a support portion protruding from the side wall portion towards the interior of the back bezel. At the second side edge, a bottom surface of the side wall portion is disposed on a top surface of the wall, and an outer side surface of the side wall portion and an outer side surface of the wall are coplanar. The display panel is supported by the support portion to be disposed on the back bezel. The tape extends at the second side edge from the outer side surface of the wall through the outer side surface of the side wall portion to the above of the display panel.

### BACKGROUND

### Technical Field

The present invention relates to a display device. Specifically, the present invention relates to a display device including a back bezel and a frame.

### Related Art

When different modules and assemblies of a display device are disposed, elements such as a back bezel and a frame may be used for locating and assembling. However, usage of such back bezel and frame may reduce a space that can be occupied by the modules and assemblies inside the display device, so as to further deteriorate the actuation or performance quality of the entire display device. However, if the back bezel or the frame is omitted, in addition to the structural stability and the assembly integrity, this type of structure may increase a probability of light leakage of the display device, or may increase a risk of impact or impurity pollution on internal modules and assemblies. Further, the frame or another alternative element may unexpectedly interact with a related optical assembly to affect or degrade light emitting, thereby generating an optical defect. Therefore, an architecture of a display device that can reduce or avoid the foregoing defect and includes expected structural stability and assembly integrity needs to be designed and developed.

### SUMMARY

### Technical Means to Solve Problems

To solve the foregoing problems, the present invention provides a display device including a back bezel, a frame, a display panel, and a tape. The back bezel includes a base plate and a wall extending along a periphery of the base plate, and has a first side edge and a second side edge intersecting the first side edge. At the first side edge, the back bezel further has a separating plate extending and protruding towards the interior of the back bezel. The frame is disposed along the periphery of the base plate, and has a side wall portion and a support portion protruding from the side wall portion towards the interior of the back bezel. At the second side edge, a bottom surface of the side wall portion is disposed on a top surface of the wall, and an outer side surface of the side wall portion and an outer side surface of the wall are coplanar. The display panel is supported by the support portion to be disposed on the back bezel. The tape extends at the second side edge from the outer side surface of the wall through the outer side surface of the side wall portion to the above of the display panel.

Another embodiment of the present invention provides a display device including a back bezel, a frame, a display panel, and a tape. The back bezel includes a base plate and a wall extending along a periphery of the base plate, and has a first side edge and a second side edge intersecting the first side edge. At the first side edge, the back bezel further has a separating plate extending and protruding towards the interior of the back bezel. The frame is disposed along the periphery of the base plate, and has a side wall portion and a support portion protruding from the side wall portion towards the interior of the back bezel. At the second side edge, the top of the wall further has a plurality of notches concaving towards the base plate, and the side wall portion has a plurality of protrusions respectively protruding towards the base plate to be wedging in the plurality of notches correspondingly. At the second side edge, a bottom surface of the side wall portion is disposed on a top surface of the wall, and an outer side surface of the side wall portion and an outer side surface of the wall are at least partially coplanar. The display panel is supported by the support portion to be disposed on the back bezel. The tape extends at the second side edge from the outer side surface of the wall through the outer side surface of the side wall portion to the above of the display panel.

Still another embodiment of the present invention provides a display device including a back bezel, a frame, a display panel, and a tape. The back bezel includes a base plate and a wall extending along a periphery of the base plate, and has a first side edge and a second side edge intersecting the first side edge. At the first side edge, the back bezel further includes a separating plate extending and protruding towards the interior of the back bezel. The frame is disposed along the periphery of the base plate, and has a side wall portion and a support portion protruding from the side wall portion towards the interior of the back bezel. At the second side edge, the wall has a plurality of segments, and the side wall portion has a plurality of protrusions respectively protruding towards the base plate to be wedging between the plurality of segments correspondingly. At the second side edge, a bottom surface of the side wall portion apart from the plurality of protrusions is disposed on a top surface of the wall, and an outer side surface of the side wall portion and an outer side surface of the wall are at least partially coplanar. The display panel is supported by the support portion to be disposed on the back bezel. The tape extends at the second side edge from the outer side surface of the wall through the outer side surface of the side wall portion to the above of the display panel.

### Effects Compared to the Prior Art

According to the display device provided in the embodiments of the present invention, a back bezel and a frame may be disposed to help assemble modules and assemblies of the display device, and improve a space occupied by at least some assemblies such as an optical film and a light guide plate. In addition, according to the display device provided in the embodiments of the present invention, problems such as light leakage and impact or impurity pollution on the internal modules and assemblies can be reduced or avoided by disposing a back bezel and a frame. Further, according to the display device provided in the embodiments of the present invention, a frame may be avoided to be directly disposed adjacent to an optical assembly to face an end edge of a side edge of the optical assembly such as an optical film or a light guide plate in a manner that may affect or degrade light emitting, thereby improving or reducing an optical defect that may be caused by disposing the frame and the optical element adjacently during assembly.

### BRIEF DESCRIPTION OF THE DRAWINGS

FIG. 1 is a plane top view of a display device according to an embodiment of the present invention.

FIG. 2 is a cross-sectional view of the display device taken along a cross-section line A-A′ in FIG. 1.

FIG. 3 is a cross-sectional view of the display device taken along a cross-section line B-B′ in FIG. 1.

FIG. 4 is a cross-sectional view of the display device taken along a cross-section line C-C′ in FIG. 1.

FIG. 5 is a schematic flowchart of assembling a display device according to an embodiment of the present invention.

FIG. 6 is a schematic cross-sectional view illustrating a first side edge and a third side edge of a display device during assembly according to an embodiment of the present invention.

FIG. 7 is a schematic cross-sectional view illustrating a second side edge and a fourth side edge of a display device during assembly according to an embodiment of the present invention.

FIG. 8 is a schematic cross-sectional view illustrating a second side edge and a fourth side edge of a display device in a step P22 according to an embodiment of the present invention.

FIG. 9A to FIG. 9B are schematic diagrams of a structure and a configuration of a second side edge of a display device according to another embodiment of the present invention.

FIG. 10A to FIG. 10E are schematic diagrams of a structure and a configuration of a second side edge of a display device according to still another embodiment of the present invention.

### DETAILED DESCRIPTION

Various embodiments are described below, and a person of ordinary skill in the art may readily understand the spirit and principle of the present invention with reference to the description and accompanying drawings. However, although some particular embodiments are described in detail herein, these embodiments are merely used as examples, and in all aspects, there embodiments are not regarded as a limitative or exhaustive meaning. Therefore, for a person of ordinary skill in the art, various changes and modifications made to the present invention are apparent and easy to be achieved without departing from the spirit and principle of the present invention.

The thickness of a layer, a film, a panel, a region, and the like is amplified for clarity in the accompanying drawings. In the entire specification, same element symbols indicate the same elements. It should be understood that, when an element such as a layer, a film, a region, or a substrate is referred to as “on” or “connected to” another element, it may be directly on another element or be connected to another element, or an intermediate element may further exist. By contrast, when an element is referred to as “directly on another element” or “directly connected to” another element, there is no intermediate element. The “connected” used herein may refer to be physically and/or electrically connected. Besides, the “electrically connected” or “coupled” may refer to that other elements exist between two elements.

It should be understood that, although terms such as “first”, “second”, and “third” are used to describe various elements, components, regions, layers and/or parts herein, the terms are not intended to limit these elements, components, regions, and/or parts. The terms are only intended to distinguish one element, component, region, layer, or part from another element, component, region, layer or part. Therefore, a “first element”, “first component”, “first region”, “first layer”, or “first part” described hereafter may be otherwise referred to as a second element, component, region, layer, or part without departing from the teaching herein.

Terms used herein are only intended to describe a particular embodiment rather than to limit the present invention. Unless the content clearly indicates otherwise, the singular forms such as “a”, “one”, and “the” used herein are intended to include plural forms, including “at least one”. “Or” indicates “and/or”. The term “and/or” used herein includes any and all combinations of one or more related listed items. It should also be understood that, when used in this specification, the terms “include” and “comprise” indicate existence or addition of the specific feature, region, entirety, step, operation, element, and/or component. However, existence or addition of one or more other features, regions, entirety, steps, operations, elements, components and/or combinations thereof is not excluded.

The exemplary embodiments are described with reference to schematic cross-sectional views of preferred embodiments herein. Therefore, it may be predicted that shape changes deviated from the shape shown in the drawings might be resulted from a manufacturing technology and/or a tolerance, and the like. Therefore, the embodiments in the present invention shall not be explained as being limited to a particular shape of the region shown herein, but include, for example, a shape deviation caused by manufacturing. For example, a shown or described flat region may generally have a rough and/or non-linear feature. In addition, the shown acute angle may be round. Therefore, the region shown in the figure is essentially schematic, and their shapes are not intended to indicate a precise shape of the region or limit claims of this application.

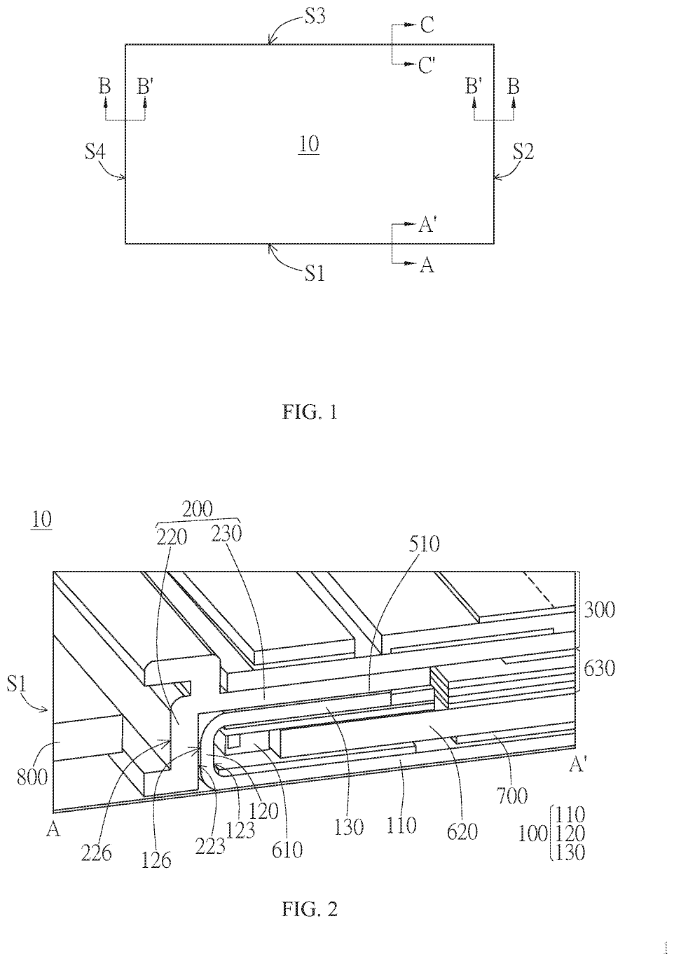

Referring to FIG. 1 and FIG. 2 to FIG. 4 that are cross-sectional views taken along different cross-section lines in FIG. 1, according to an embodiment of the present invention, a display device 10 may have a back bezel 100, a frame 200, a display panel 300, and a tape 400. The back bezel 100 includes a base plate 110 and a wall 120 extending along a periphery of the base plate 110. In addition, the frame 200 is disposed along the periphery of the base plate 110, so that the frame 200 may roughly correspond to the wall 120 of the back bezel 100 and may be assembled or jointed with the back bezel 100. Further, the frame 200 may further have a side wall portion 220 and a support portion 230 protruding from the side wall portion 220 towards the interior of the back bezel 100, and the display panel 300 may be supported by the support portion 230 to be disposed on the back bezel 100.

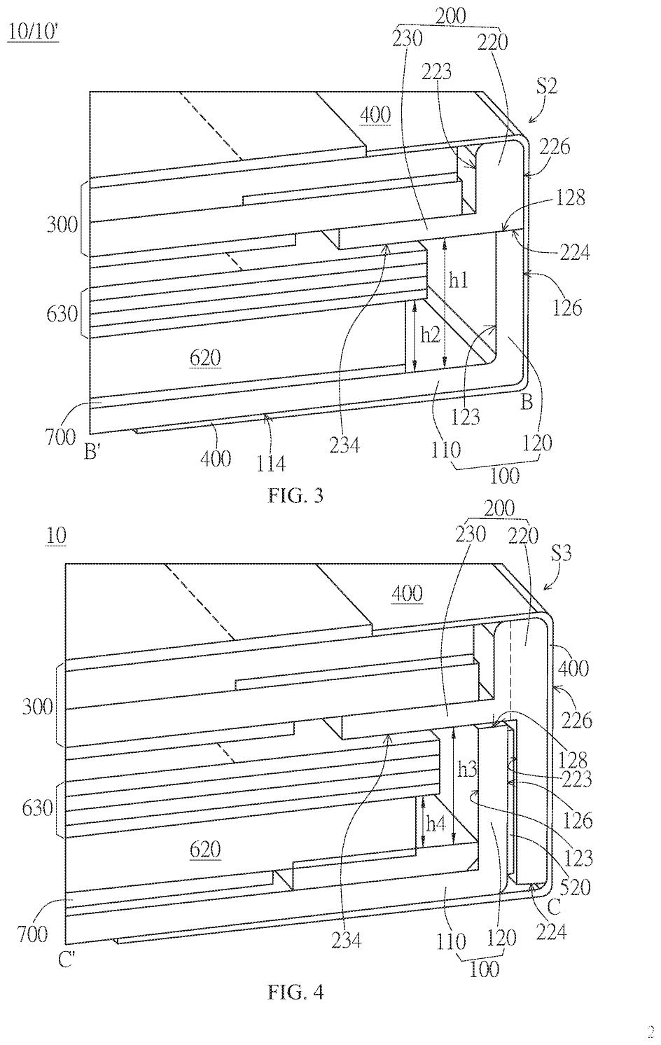

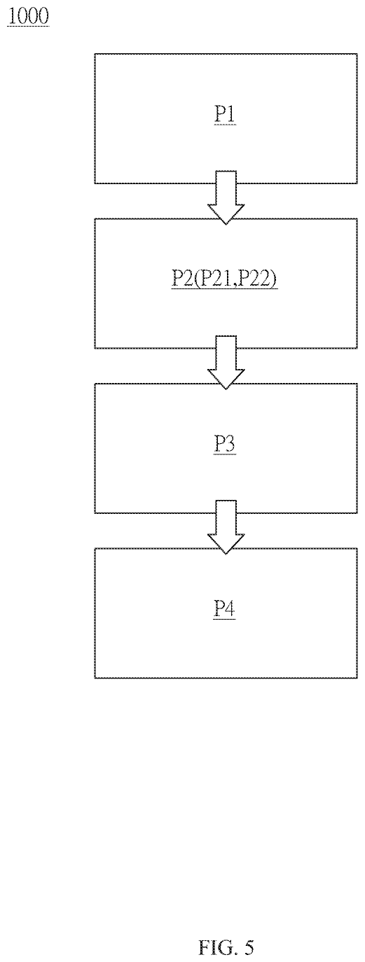

As described above, for ease of description, the base plate 110 may be defined as having a first side edge S1, a second side edge S2 and a fourth side edge S4 intersecting the first side edge S1, and a third side edge S3 opposite to the first side edge S1. FIG. 2 shows the configuration and the architecture at the first side edge S1; FIG. 3 shows the configuration and the architecture at the second side edge S2 or at the fourth side edge S4; and FIG. 4 shows the configuration and the architecture at the third side edge S3.

As described above, referring to FIG. 2, at the first side edge S1, the back bezel 100 may further have a separating plate 130 extending and protruding towards the interior of the back bezel 100, and the display device 10 may further include a light source 610 and a light guide plate 620. The light source 610 may be disposed between the base plate 110 and the separating plate 130 along the first side edge S1, and the light guide plate 620 may be disposed on the base plate 110 at a side of the light source 610 opposite to the first side edge S1. According to another embodiment of the present invention, a reflecting plate 700 may be disposed between the light guide plate 620 and the base plate 110, so as to improve light guiding and light emitting effects of the display device 10. In addition, according to this embodiment, the display device 10 further includes one or more optical films 630 disposed on the light guide plate 620.

In some embodiments, at the first side edge S1, an orthographic projection of the support portion 230 and an orthographic projection of the one or more optical films 630 on the base plate 110 do not overlap each other. However, the optical assemblies disposed on the base plate 110 and configurations thereof provided herein are merely used as an example, and the present invention is not limited thereto.

Further, according to some embodiments, at the first side edge S1, the display device 10 may be further electrically connected to another element 800 such as a printed circuit board or another assembly configuration, so as to control the display device 10 or to provide power to the display device 10, and these parts are not described in detail in this specification. In addition, the foregoing description is merely used as an example, and the present invention is not limited thereto. For example, when independent operation is possible, the display device 10 according to the present invention may not be further connected to another element.

At the first side edge S1, since the separating plate 130 is disposed, it can be avoided or reduced that light emitted by the light source 610 enters the display panel 300 or leaves the display device 10 through an unexpected path. As described above, at the first side edge S1, the support portion 230 of the frame 200 may be disposed on the separating plate 130, and the support portion 230 and the separating plate 130 may be attached to each other by disposing a double-sided tape 510 between the support portion 230 and the separating plate 130. However, the present invention is not limited thereto, and another element may be inserted between the support portion 230 and the separating plate 130, or the attachment is performed in another manner. In addition, according to some embodiments, at the first side edge S1, the frame 200 may not have the support portion 230, and the display panel 300 may be directly supported by the separating plate 130.

Further, at the first side edge S1, the side wall portion 220 of the frame 200 may have an inner side surface 223 relatively facing the interior of the back bezel 100 and an outer side surface 226 relatively opposing the interior of the back bezel 100, and the wall 120 of the back bezel 100 may have an inner side surface 123 relatively facing the interior of the back bezel 100 and an outer side surface 126 relatively opposing the interior of the back bezel 100. The inner side surface 223 of the side wall portion 220 of the frame 200 may abut against the outer side surface 126 of the wall 120, such that the side wall portion 220 covers the outer side surface 126 of the wall 120.

According to this embodiment, at the first side edge S1, the separating plate 130 and the wall 120 may be disposed between the one or more optical films 630 and the side wall portion 220. Therefore, an end edge of a side edge of the optical film 630 may be avoided to be directly adjacent to the side wall portion 220 of the frame 200 that may absorb light or affect a light emitting effect such as reflecting, thereby improving the optical effect of the optical film 630.

Next, further referring to FIG. 3, the configuration of the display device 10 at the second side edge S2 intersecting the first side edge S1 will be described. In addition, the fourth side edge S4 shown in FIG. 1 is the same as or similar to the second side edge S2, and that will not be described repeatedly herein.

As described above, at the second side edge S2, the side wall portion 220 is disposed above the wall 120 and is away from the base plate 110 relative to the wall 120. Specifically, a bottom surface 224 of the side wall portion 220 may be directly disposed above a top surface 128 of the wall 120, and the side wall portion 220 does not abut against the inner side surface 123 or the outer side surface 126 of the wall 120. In this embodiment, the outer side surface 226 of the side wall portion 220 and the outer side surface 126 of the wall 120 may be coplanar, and the support portion 230 of the frame 200 may further protrude from the inner side surface 223 of the side wall portion 220 towards the interior of the back bezel 100 to support the display panel 300.

Further, the display device 10 according to this embodiment may have a tape 400. The tape 400 may extend at the second side edge S2 from the outer side surface 126 of the wall 120 through the outer side surface 226 of the side wall portion 220 to the above of the display panel 300. For example, the tape 400 may extend from the outer side of the bottom surface 114 of the base plate 110 through the outer side surface 126 of the wall 120 and the outer side surface 226 of the side wall portion 220 to the above of the display panel 300 in sequence. That is, for example, the tape 400 may be attached to the coplane of the outer side surface 226 of the side wall portion 220 and the outer side surface 126 of the wall 120, and extend and fold up to be attached to the above of the display panel 300. In this way, at the second side edge S2, the assembly integrity and structural stability between the wall 120 of the back bezel 100, the side wall portion 220 of the frame 200, and the display panel 300 are enhanced under the assistance of the tape 400.

According to an embodiment of the present invention, based on the foregoing architecture, the frame 200 may not extend between the wall 120 of the back bezel 100 and the optical assemblies including the light guide plate 620 and the optical film 630. Therefore, any one or a combination of the optical assemblies including the light guide plate 620 and the optical film 630 may have a relatively large occupied space. For example, at the second side edge S2, any one or a combination of the optical assemblies including the light guide plate 620 and the optical film 630 may at least partially extend between the support portion 230 and the base plate 110. Further, any one or a combination of the optical assemblies including the light guide plate 620 and the optical film 630 may extend towards an end edge of a side edge of the base plate 110 to the greatest extent. In this way, the effect of these optical assemblies can be maximized as much as possible, and an optical defect such as a dark line or a bright line at the side edge caused by these optical assemblies retracting at the end edge of the side edge of the base plate 110 towards the interior of the back bezel 100 can be reduced or avoided. In addition, end edges of side edges of these optical assemblies are not directly adjacent to a frame 200 made of materials having a relatively large light absorbing capability, such as a rubber. For example, at the second side edge S2, the frame 200 does not have the side wall portion 220, and neither the side wall portion 220 at the first side edge S1 described above nor a side wall portion 220 at the third side edge S3 described below is directly adjacent to any one or a combination of the optical assemblies including the light guide plate 620 and the optical film 630. Instead, the side wall portion 220 is disposed on an outer side surface of the wall 120 of the back bezel 100 generally made of metal. In addition, relative to the base plate 110, the support portion 230 of the frame 200 is higher than any one or a combination of the optical assemblies including the light guide plate 620 and the optical film 630. For example, at the second side edge S2, a vertical distance h1 between the bottom surface 224 of the side wall portion 220 and the base plate 110 is greater than a vertical distance h2 between the one or more optical films 630 and the base plate 110. Therefore, optical attenuation generated when the frame 200 is disposed adjacent to the end edges of the side edge of any one or a combination of the optical assemblies including the light guide plate 620 and the optical film 630 can be improved. Therefore, attenuation of the light emitting capability of the entire display device 10 can be reduced or avoided.

Next, further referring to FIG. 4, the configuration of the display device 10 at a third side edge S3 opposite to the first side edge S1 is described below. As described above, specifically, at the third side edge S3, the top surface 128 of the wall 120 abuts against a bottom surface 234 of the support portion 230, and the outer side surface 126 of the wall 120 abuts against the inner side surface 223 of the side wall portion 220. In this embodiment, the display device 10 may further include a double-sided tape 520 disposed between the outer side surface 126 of the wall 120 and the inner side surface 223 of the side wall portion 220. However, the present invention is not limited thereto. Based on this architecture, at least a part of the outer side surface 126 of the wall 120 is covered by the side wall portion 220, and the frame 220 does not extend between the wall 120 and any one or a combination of the optical assemblies including the light guide plate 620 and the optical film 630. That is, the wall 120 is disposed between the side wall portion 220 and the optical assemblies such as the one or more optical films 630. In this way, similar to the architecture in FIG. 3, at the third side edge S3, any one or a combination of the optical assemblies including the light guide plate 620 and the optical film 630 may at least partially extend between the support portion 230 and the base plate 110 at the second side edge S2. In addition, a vertical distance h3 between the bottom surface 234 of the support portion 230 and the base plate 110 or another element disposed on the base plate 110 is greater than a vertical distance h4 between the one or more optical films 630 and the base plate 110 or another element disposed on the base plate 110. Therefore, the effect of these optical assemblies can be maximized as much as possible, and an optical defect such as a dark line or a bright line at the side edge caused by these optical assemblies retracting at the end edge of the side edge of the base plate 110 towards the interior of the back bezel 100 to be disposed unevenly can be reduced or avoided. Further, optical attenuation generated when the frame 200 is directly disposed adjacent to the end edge of the side edge of any one or a combination of the optical assemblies including the light guide plate 620 and the optical film 630 can also be improved. Therefore, attenuation of the light emitting capability of the entire display device 10 can be reduced or avoided.

However, according to a display device 10′ of some embodiments of the present invention, a third side edge S3 may be essentially the same as the architecture of the configuration shown in FIG. 3. That is, according to a display device 10′ of another embodiment, a second side edge S2, a third side edge S3, and a fourth side edge S4 are all essentially the same as or similar to the architecture in FIG. 3, so that the bottom surface 224 of the side wall portion 220 is disposed on the top surface 128 of the wall 120, and the outer side surface 226 of the side wall portion 220 and the outer side surface 126 of the wall 120 are coplanar. Related details are not described repeatedly herein.

A process of assembling the above display device 10 according to an embodiment of the present invention will be described below with reference to FIG. 5 to FIG. 8.

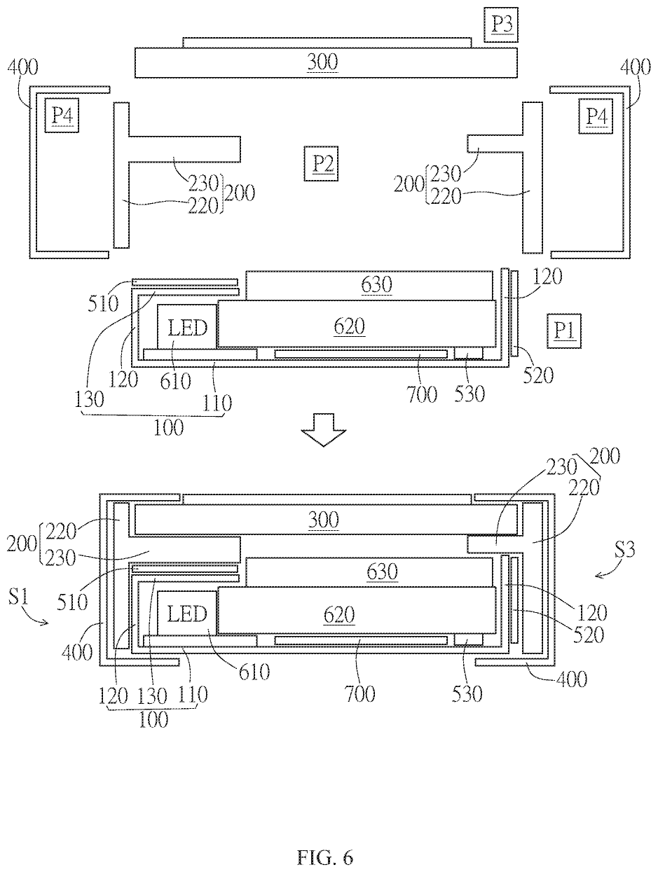

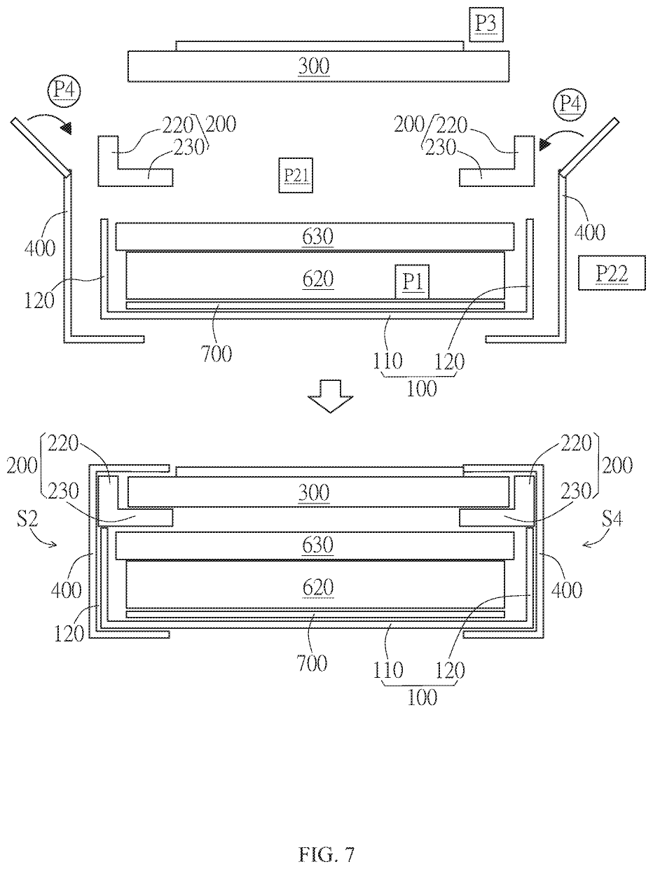

As described above, referring to FIG. 5, according to an embodiment of the present invention, a method 1000 for manufacturing and assembling the above display device 10 may include step P1, step P2, step P3, and step P4 in sequence. Further, step P2 may include substep P21 and substep P22 in sequence, and all corresponding steps are marked in schematic diagrams shown in FIG. 6 to FIG. 8. Specifically, FIG. 6 is a cross-sectional conceptual view taken along a connection line from the first side edge S1 to the third side edge S3 of the display device 10, FIG. 7 is a cross-sectional conceptual view taken along a connection line from the second side edge S2 to the fourth side edge S4 of the display device 10, and FIG. 8 is a cross-sectional view of a state of the display device 10 at the second side edge S2 or at the fourth side edge S4 in substep P22.

As described above, according to this embodiment, referring to FIG. 6 and FIG. 7, the manufacturing and assembling method 1000 may include step P1 of disposing optical assemblies such as the light source 610, the light guide plate 620, the optical film 630, and the reflecting plate 700 on the base plate 110 of the back bezel 100. As described above, referring to FIG. 6, the light guide plate 620 may be connected to the base plate 110 at an end opposite to the light source 610 by using a double-sided tape 530, and an end of the light guide plate 620 adjacently connected to the light source 610 is attached to another element without using the double-sided tape to prevent the double-sided tape from directly affecting the light emitting of the light source 610 or attenuating the light emitting of the light source 610. However, this is merely used as an example, and the present invention is not limited thereto. In addition, a double-sided tape 510 may be finally disposed on the separating plate 130 at the first side edge S1 in step P1, and the double-sided tape 520 is disposed on the outer side of the wall 120 at the third side edge S3, for later attachment to the frame 200 in subsequent steps. However, the configuration of the optical assemblies and usage or configuration position of the double-sided tape are merely used as an example, and the present invention is not limited thereto.

According to this embodiment, step P1 may be manually assembled. However, if the technology allows, step P1 may be assembled by using any mechanized or automatic process.

Then, still referring to FIG. 6 and FIG. 7, after step P1, step P2 of assembling the back bezel 100 and the frame 200 may be performed in sequence. In step P2, at the first side edge S1, the support portion 230 and the side wall portion 220 of the frame 200 may be respectively disposed corresponding to abut against the separating plate 130 and the wall 120 of the back bezel 100; at the third side edge S3, the support portion 230 and the side wall portion 220 of the frame 200 may be respectively disposed corresponding to abut against the top and the outer side of the wall 120 of the back bezel 100; and at the second side edge S2 and the fourth side edge S4, the bottom of the side wall portion 220 of the frame 200 may be disposed corresponding to abut against the top of the wall 120 of the back bezel 100. When a double-sided tape is disposed between the frame 200 and the back bezel 100, adhesion and attachment may also be performed during assembly.

When step P2 is performed, at the second side edge S2 and the fourth side edge S4, in addition to substep P21 of assembling the frame 200 and the back bezel 100, referring to FIG. 8, step P2 further includes substep P22 of attaching the tape 400 along the coplane of the outer side of the wall 120 of the back bezel 100 and the outer side of the side wall portion 220 of the frame 200. As described above, after attaching the tape 400 to the back bezel 100 and extending to the side wall portion 220, a section of the tape 400 may be reserved without attaching, and this section of the tape 400 is attached to the display panel 300 when step P4 is completed.

Then, after step P2 is completed, according to this embodiment, step of disposing the display panel 300 on the support portion 230 of the frame 200 may be performed in sequence. Specifically, at the first side edge S1, the second side edge S2, the third side edge S3, and the fourth side edge S4, there are support portions 230 extending from the side wall portion 220 of the frame 200 towards the interior of the back bezel 100, and the display panel 300 may be disposed on the support portion 230 correspondingly relative to the first side edge S1, the second side edge S2, the third side edge S3, and the fourth side edge S4, so as to be disposed on the back bezel 100 and be located in the display device 10.

According to some embodiments, the side wall portion 220 of the frame 200 may protrude away from a bottom surface and a support surface of the support portion 230, so as to further limit the end edge of the side edge of the display panel 300 disposed on the support surface of the support portion 230, and avoid collision or exposure of the display panel 300 and the back bezel 100. However, the present invention is not limited thereto.

After the configuration of the display panel 300 is completed, according to this embodiment, step P4 of encapsulating the display device 10 by using the tape 400 may be further included after step P3. Specifically, as described above, the tape 400 reserved at the second side edge S2 and the fourth side edge S4 in step P22 may fold back towards the display panel 300 to be attached to the above of the display panel 300, so as to complete the assembly and attachment of the back bezel 100, the frame 200, and the display panel 300 at the second side edge S2 and the fourth side edge S4. In addition, at the first side edge S1 and the third side edge S3, the tape 400 may be attached from the outer side of the bottom of the back bezel 100 along outlines of the back bezel 100, the frame 200 and the display panel 300 similarly. For example, at the first side edge S1 and the third side edge S3, the tape 400 may be folded back and be attached on the display panel 300 in a manner of starting from the outer side of the bottom of the base plate 110 through the border of the back bezel 100 and the side wall portion 220 of the frame 200, the outer side of the side wall portion 220, and then passing through the top of the side wall portion 220. Therefore, the assembly and attachment of the back bezel 100, the frame 200, and the display panel 300 at the first side edge S1 and the third side edge S3 can be improved. However, the foregoing description is merely used as an example, and according to an embodiment of the present invention, the tape 400 may not be disposed on the outer sides of the first side edge S1 and the third side edge S3. In addition, the sequence of the foregoing steps of attaching the tape 400 may also be adjusted correspondingly. For example, partial attachment may be performed on the back bezel 100 in step P1, then the tape 400 may be attached on the frame 200 or the display panel 300 in sequence as the assembly proceeds, and the present invention is not limited thereto.

According to some embodiments of the present invention, the assembly in step P2 to step P4 may be performed by mechanization or automation. However, the present invention is not limited thereto, and the assembly in step P2 to step P4 may be performed manually as in step P1. In addition, for ease of the foregoing assembly, according to another embodiment, a jig or a module is disposed in advance to assist in locating or limiting the assemblies of the display device 10. For example, when the back bezel 100 is disposed on the jig or the module, the jig or the module may define a preset space for the insertion of the side wall portion 220 of the frame 200 at the first side edge S1 or the third side edge S3. Alternatively, the tape 400 may be located on an inner wall of the jig or the module using a way such as vacuum adsorption in advance for ease of the attachment during assembly. However, the foregoing description is merely used as an example, and the present invention is not limited thereto.

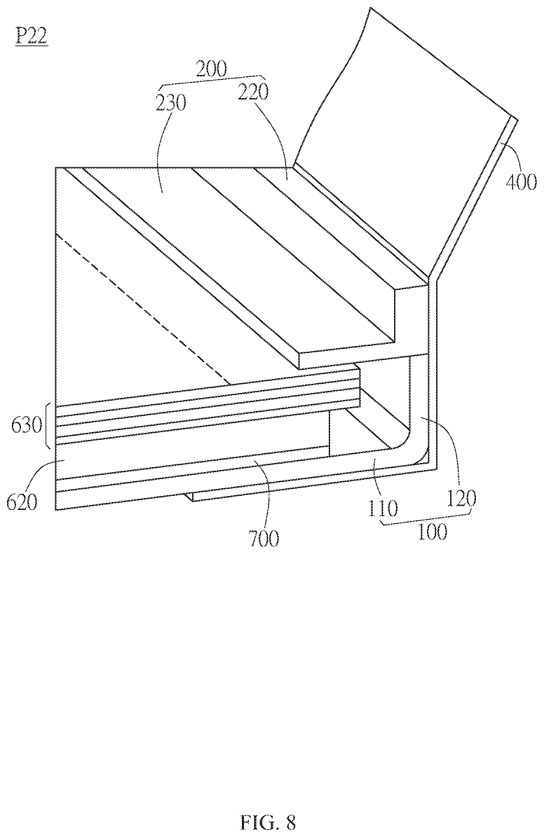

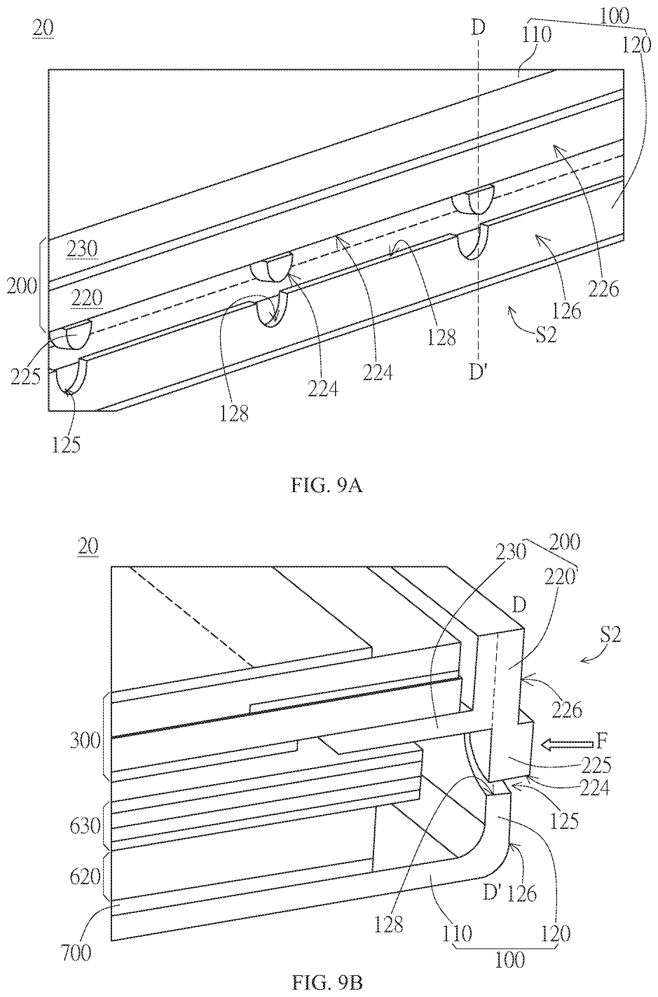

Then, the architecture of a display device 20 according to still another embodiment of the present invention will be described with reference to FIG. 9A to FIG. 9B. FIG. 9B is a cross-sectional view taken along a cross-section line D-D′ in FIG. 9A.

As described above, according to this embodiment, a first side edge S1 of the display device 20 may be the same as or similar to the first side edge S1 of the display device 10 described above with reference to FIG. 1 to FIG. 2, and a third side edge S3 of the display device 20 may be the same as or similar to the third side edge S3 of the display device 10 described above with reference to FIG. 1 to FIG. 4. Details are not described repeatedly herein. That is, a difference between this embodiment and the display device 10 described above with reference to FIG. 1 to FIG. 4 is the configuration at a second side edge S2 or a fourth side edge S4. In addition, similarly, the configuration at the second side edge S2 or the fourth side edge S4 of this embodiment may be implemented on the third side edge S3, and details are not described repeatedly herein.

As described above, according to this embodiment, at the second side edge S2 of the display device 20, the top of the wall 120 further has a plurality of notches 125 concaving towards the base plate 110, and the side wall portion has a plurality of protrusions 225. The plurality of protrusions 225 respectively protrudes towards the base plate 110 to be wedging in the plurality of notches 125 correspondingly. In this way, the bottom surface 224 of the side wall portion 220 may be disposed on the top surface 128 of the wall 120, and the outer side surface 226 of the side wall portion 220 and the outer side surface 126 of the wall 120 may be at least partially coplanar.

The size of plurality of protrusions 225 indicated above may be set greater than a size that may be expectedly placed into the plurality of notches 125 originally, or be set slightly protruding from the coplane of the outer side surface 226 of the side wall portion 220 and the outer side surface 126 of the wall 120. Then, the plurality of protrusions 225 is melted in a manner such as fusing F, so as to be welded with the wall 120. In this way, in addition to the advantages with reference to the above display device 10, the attachment stability between the back bezel 100 and the frame 200 can be further improved.

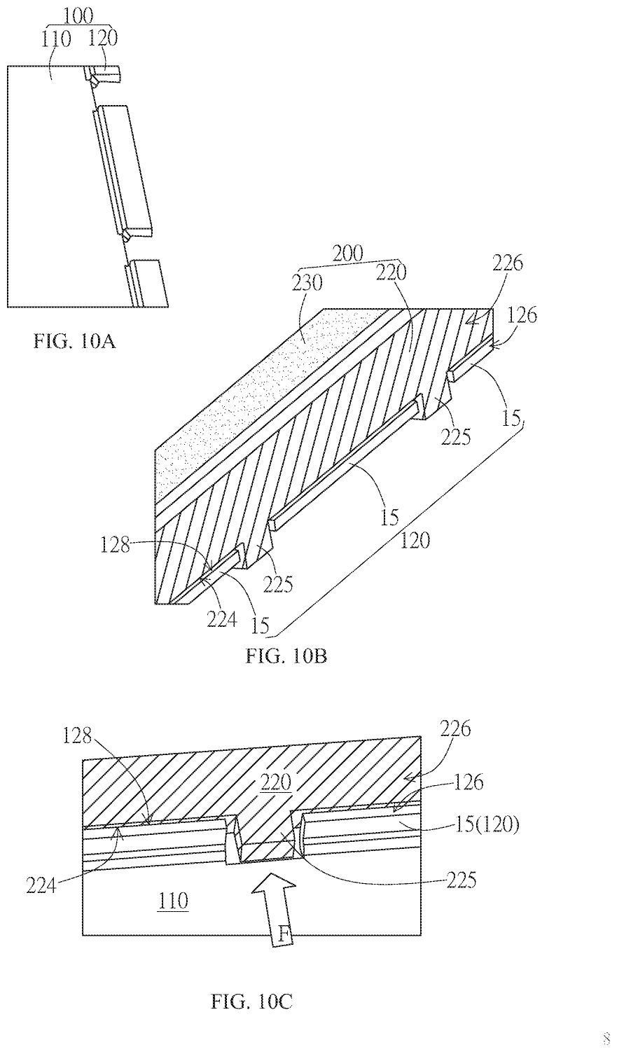

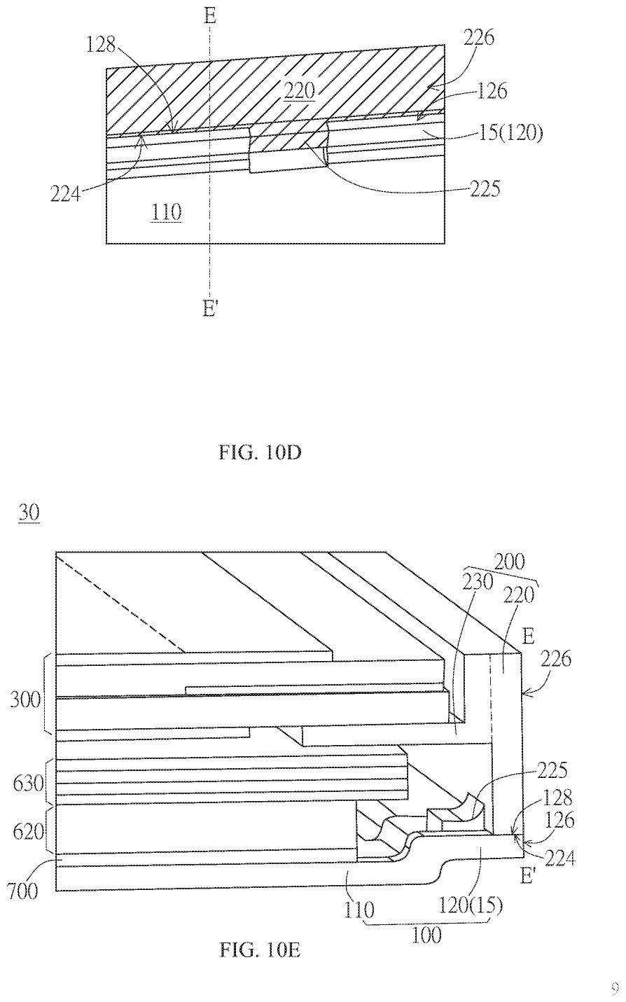

Further, the architecture of a display device 30 according to still another embodiment of the present invention will be described with reference to FIG. 10A to FIG. 10E. FIG. 10E is a cross-sectional view taken along a cross-section line E-E′ in FIG. 10D.

As described above, according to this embodiment, a first side edge S1 of the display device 30 may be the same as or similar to the first side edge S1 of the above display device 10 with reference to FIG. 1 to FIG. 2, and a third side edge S3 of the display device 30 may be the same as or similar to the third side edge S3 of the above display device 10 with reference to FIG. 1 to FIG. 4. Details are not described repeatedly herein. That is, a difference between this embodiment and the display device 10 described above with reference to FIG. 1 to FIG. 4 is the configuration at a second side edge S2 or a fourth side edge S4. In addition, similarly, the configuration at the second side edge S2 or the fourth side edge S4 of this embodiment may be implemented on the third side edge S3, and details are not described repeatedly herein.

As described above, according to this embodiment, at the second side edge S2 of the display device 30, the wall 120 has a plurality of segments 15, and the side wall portion 220 has a plurality of protrusions 225. The plurality of protrusions 225 respectively protrudes towards the base plate 110 to be wedging between the plurality of segments 15 correspondingly. In this way, the bottom surface 224 of the side wall portion 220 apart from the plurality of protrusions 225 may be disposed on the top surface 128 of the wall 120, and the outer side surface 226 of the side wall portion 220 and the outer side surface 126 of the wall 120 are at least partially coplanar.

As shown in FIG. 10B and FIG. 10C, the plurality of protrusions 225 may be set towards the base plate 110 and protruding away from the wall 120 in advance to make the bottom surface of the protrusions 225 lower than the bottom surface of the wall 120, or be set slightly protruding from the coplane of the outer side surface 226 of the side wall portion 220 and the outer side surface 126 of the wall 120. Then, the plurality of protrusions 225 is melted in a manner such as fusing F to be welded with the wall 120, so as to form a structure in which the plurality of protrusions 225 is flush with the outer side surface and/or the bottom surface of the side wall portion 220 as shown in FIG. 10D and FIG. 10E. In addition to the advantages with reference to the display device 10, the attachment stability between the back bezel 100 and the frame 200 can be further improved according to the architecture of this embodiment.

In conclusion, according to the display device provided in the embodiments of the present invention, a back bezel and a frame may be disposed to help assemble modules and assemblies of the display device, and improve a space occupied or extended by at least some assemblies such as an optical film and a light guide plate, or make at least some assemblies such as an optical film and a light guide plate extend to be disposed on the end edge of the side edge of the display device. Therefore, according to the display device provided in the embodiments of the present invention, problems such as light leakage and impact or impurity pollution on the internal modules and assemblies can be reduced or avoided by disposing a back bezel and a frame. Further, a dispose space of the at least some assemblies can be enlarged or the dispose uniformity of the at least some assemblies can be improved. Therefore, based on this architecture, the structural strength and stability of the entire display device can be improved, and the effect or function of some assemblies such as the optical film and the light guide plate at the end edge of the side edge can also be improved.

The foregoing descriptions are merely some preferable embodiments of the present invention. It should be noted that, various changes or modifications can be made to the present invention without departing from the spirit and principle of the present invention. A person of ordinary skill in the art should understand that, the present invention is defined by the appended claims. In addition, under the intention of the present invention, any possible variation such as replacement, combination, modification, and transformation shall not exceed the scope defined by the appended claims of the present invention.

### LIST OF REFERENCE NUMERALS

10, 10′, 20, 30: display device
15: segment
100: back bezel
110: base plate
114: bottom surface
120: wall
123: inner side surface
125: notch
126: outer side surface
128: top surface
130: separating plate
200: frame
220: side wall portion
223: inner side surface
224: bottom surface
225: protrusion
226: outer side surface
230: support portion
300: display panel
400: tape
510, 520, 530: double-sided tape
610: light source
620: light guide plate
630: optical film
700: reflecting plate
800: element
1000: method
S1: first side edge
S2: second side edge
S3: third side edge
S4: fourth side edge
h1, h2, h3, h4: vertical distance
P1, P2, P3, P4: step
P21, P22: substep
F: fusing

What is claimed is:

1. A display device, comprising:
a back bezel, comprising a base plate and a wall extending along a periphery of the base plate, and having a first side edge and a second side edge intersecting the first side edge, wherein at the first side edge, the back bezel further has a separating plate extending and protruding towards the interior of the back bezel;
a frame, disposed along the periphery of the base plate, and having a side wall portion and a support portion protruding from the side wall portion towards the interior of the back bezel, wherein at the second side edge, a bottom surface of the side wall portion is disposed on a top surface of the wall, and an outer side surface of the side wall portion and an outer side surface of the wall are coplanar;
a display panel, supported by the support portion to be disposed on the back bezel; and
a tape, extending at the second side edge from the outer side surface of the wall through the outer side surface of the side wall portion to the above of the display panel.

2. The display device according to claim 1, wherein the tape extends from an outer side of a bottom surface of the base plate through the outer side surface of the wall and the outer side surface of the side wall portion to the above of the display panel.

3. The display device according to claim 1, wherein at the first side edge, the support portion is disposed on the separating plate, and an inner side surface of the side wall portion abuts against the outer side surface of the wall.

4. The display device according to claim 3, wherein at the first side edge, a double-sided tape disposed between the support portion and the separating plate is further comprised.

5. The display device according to claim 1, wherein the back bezel further has a third side edge opposite to the first side edge, and at the third side edge, the top surface of the wall abuts against a bottom surface of the support portion, and the outer side surface of the wall abuts against an inner side surface of the side wall portion.

6. The display device according to claim 5, wherein at the third side edge, a double-sided tape disposed between the outer side surface of the wall and the inner side surface of the side wall portion is further comprised.

7. The display device according to claim 1, wherein the back bezel further has a third side edge opposite to the first side edge, and at the third side edge, the bottom surface of the side wall portion is disposed on the top surface of the wall, and the outer side surface of the side wall portion and the outer side surface of the wall are coplanar.

8. The display device according to claim 1, further comprising a light source and a light guide plate, wherein the light source is disposed between the base plate and the separating plate along the first side edge, and the light guide plate is disposed on the base plate at a side of the light source opposite to the first side edge and at least partially extends between the support portion and the base plate at the second side edge.

9. The display device according to claim 8, further comprising one or more optical films, wherein the one or more optical films are disposed on the light guide plate, and at least partially extend between the support portion and the base plate at the second side edge.

10. The display device according to claim 9, wherein
at the first side edge, an orthographic projection of the support portion and an orthographic projection of the one or more optical films on the base plate do not overlap each other.

11. The display device according to claim 9, wherein
at the first side edge, the separating plate and the wall are disposed between the one or more optical films and the side wall portion, and
at the second side edge, a vertical distance between the bottom surface of the side wall portion and the base plate is greater than a vertical distance between the one or more optical films and the base plate.

12. The display device according to claim 11, wherein the back bezel further has a third side edge opposite to the first side edge, and at the third side edge, the wall is disposed between the one or more optical films and the side wall portion, or the vertical distance between the bottom surface of the side wall portion and the base plate is greater than the vertical distance between the one or more optical films and the base plate.

13. A display device, comprising:
a back bezel, comprising a base plate and a wall extending along a periphery of the base plate, and having a first side edge and a second side edge intersecting the first side edge, wherein at the first side edge, the back bezel further has a separating plate extending and protruding towards the interior of the back bezel;
a frame, disposed along the periphery of the base plate, and having a side wall portion and a support portion protruding from the side wall portion towards the interior of the back bezel, wherein at the second side edge, a top surface of the wall further has a plurality of notches concaving towards the base plate, and the side wall portion has a plurality of protrusions respectively protruding towards the base plate to be wedging in the plurality of notches correspondingly, a bottom surface of the side wall portion is disposed on the top surface of the wall, and an outer side surface of the side wall portion and an outer side surface of the wall are at least partially coplanar.
a display panel, supported by the support portion to be disposed on the back bezel; and
a tape, extending at the second side edge from the outer side surface of the wall through the outer side surface of the side wall portion to the above of the display panel.

14. A display device, comprising:
a back bezel, comprising a base plate and a wall extending along a periphery of the base plate, and having a first side edge and a second side edge intersecting the first side edge, wherein at the first side edge, the back bezel further comprises a separating plate extending and protruding towards the interior of the back bezel;
a frame, disposed along the periphery of the base plate, and having a side wall portion and a support portion protruding from the side wall portion towards the interior of the back bezel, wherein at the second side edge, the wall has a plurality of segments, and the side wall portion has a plurality of protrusions respectively protruding towards the base plate to be wedging between the plurality of segments correspondingly, a bottom surface of the side wall portion apart from the plurality of protrusions is disposed on a top surface of the wall, and an outer side surface of the side wall portion and an outer side surface of the wall are at least partially coplanar.
a display panel, supported by the support portion to be disposed on the back bezel; and
a tape, extending at the second side edge from the outer side surface of the wall through the outer side surface of the side wall portion to the above of the display panel.
